(19) United States
(12) Patent Application Publication
(10) Pub. No.: US 2011/0234378 A1
(43) Pub. Date: Sep. 29, 2011

(54) Tracking Device, System and Method

(75) Inventors: Ian Radley, Bishop Auckland Durham (GB); Amab Basu, Durham (GB); Max Robinson, Durham (GB)

(73) Assignee: Kromek Limited

(21) Appl. No.: 13/127,780

(22) PCT Filed: Nov. 16, 2009
(86) PCT No.: PCT/GB2009/051542

§ 371 Date: Jun. 14, 2011

(30) Foreign Application Priority Data
Nov. 18, 2008 (GB) 0821049.4

(51) Int. Cl. H04Q 5/22

(52) U.S. Cl. 340/10.1

(57) ABSTRACT

A tracking device for tracking with a radioactive material, a container including such a device, and a tracking method are described. The device has a radiation detector associatable with a radioactive material adapted to be placed in use within a container defining a radiation-shielded enclosure for containing a radioactive material, to detect radiation activity from the material. A RF identification module associatable with the container includes a data register to store a unique product identification code, a processor with a data transfer link to the radiation detector and data register to receive and process a live data stream of activity data from the detector and associate this with the unique product identification code in a processed data packet, and an antenna to enable transmission of a data item comprising both the unique product identification code and processed activity data to a remote data capture means.

The invention relates to a device to enable the tracking and verification of identity of a radioisotope source over time, in particular within a container defining a radiation-shielded enclosure, to a system employing such a device, and to a method of tracking and verification of a radioisotope source over time.

Radioisotope sources find a variety of applications, for example as radiation sources for medical use, and for example for radiography to treat cancer patients, as irradiators to preserve food, in industrial radiography as a method of quality control of as-fabricated and welded structures, for thermoelectric generation of electricity and for other purposes.

The handling and movement of radioisotope sources through the supply, use and disposal chain poses potential threats to the environment, health and safety and security. It is desirable that the location of isotopes is tracked accurately. It has been reported that over 300 radioactive sources go missing each year (Tracking Radioactive Sources in Commerce, F T Sheldon & R M Walker et al, WM'05 Conference, Feb. 27-Mar. 3, 2005, Tucson, Ariz.). This loss of radioactive material poses an environmental health and safety threat and also a security threat.

An effective system for tracking and monitoring of radioisotope sources will increase security on radioactive shipments and help prevent inadvertent or illegal loss of sources. Methods for tracking of assets and personnel using RFID devices are known and recent advances have been assisted by developments in electronics, wireless communications and global positioning systems. Such systems are widely used for example in the global tracking of shipping containers. In a possible example of the application of RFID to the tracking of radioisotopes a system may use RFID tags attached to radioisotope containers to track the location of the container.

However, radioisotope containers present a number of very different problems to shipping containers, and not merely considerations of scale. It is generally necessary that a radioisotope is contained within a suitable enclosure or capsule for safe handling, for example in a medical facility such as a hospital, and therefore there will be no chance that any radio signal can be transmitted from the inside. Any RFID device that might be used will need to transmit from the outside. One major shortfall in RFID systems for tracking radioisotopes using RFID tags is therefore that the RFID devices are attached to the containers and only give an indication of the whereabouts of the container. It is not possible to verify that the contents of the container within the radiation-shielded enclosure are as they should be without opening the container to carry out an inspection of the radioisotope source. This limits the effectiveness of the tracking system as regards tracking the radioisotope sources themselves, since verification of radioisotope contents, as opposed to mere verification of the container, necessarily requires compromising the radiation protection provided by the enclosure. A system which verifies both enclosing container and enclosed contents without compromising the radiation protection is to be preferred

Thus, in accordance with the invention in a first aspect a tracking device for use with a radioactive material comprises:
a radiation detector associatable with a radioactive material in that it is adapted to be placed in use within a container for containing a radioactive material in a radiation-shielded enclosed volume, to detect radiation activity from the material in the enclosed volume;
a radio frequency identification module associatable with a container for containing a radioactive material, which comprises at least:
   a data register to store a unique product identification code,
   a processor with a data transfer link to each of the radiation detector and data register to receive and process a live data stream of activity data from the detector and associate this with the unique product identification code in a processed data packet,
   an antenna to enable transmission of a data item comprising both the unique product identification code and processed activity data to a remote data capture means,
wherein at least the antenna is adapted to be placed in use in mechanical association with a container but outside the radiation shielded enclosed volume.

A tracking device in accordance with the invention is intended in particular for use with a radioactive isotope source contained within a suitable enclosure which is designed to allow its safe handling by containing radiation in an enclosed volume and preventing radiation from being transmitted to the environment external to the enclosed volume. The container this comprises radiation shielding to define when closed a radiation-shielded enclosure substantially radiologically isolated from the external environment. A radiation detector is provided for association with a radioisotope source and in particular for placement into an enclosure adapted to contain such a radioisotope source for detecting radiation. Further means are provided comprising elements of a radio frequency identification module. The radio frequency identification module comprises a data register storing a unique product identification code which serves uniquely to identify a radioactive material with which it is associated and in the particular case a container to which it is attached or integrally formed with, and an antenna to allow this to be retrieved by interrogation by and/or transmitted to a remote data capture means. To that extent the radio frequency identification module functions in similar manner to a conventional RFID tag.

However, at least the antenna of the radio frequency identification module is adapted to be placed in mechanical association with a container but outside a contained volume and hence outside the radiation-shielded enclosed volume, but the radio frequency identification module additionally comprises a processor capability with a first data link to the detector to receive dynamically streamed activity data during use from the detector inside the radiation-shielded enclosed volume. The processor has a further data link to the data register, for example in that the data register is integral with the processor in a single integrated circuit or like means. This enables the processor to co-process the unique identification code with the streamed activity data and generate a data item combining both the unique identification code and activity data. The antenna associated with the radio frequency identification module enables transmission of this combination data item to a remote data capture means, for example on interrogation of the device by such a remote data capture means.

In prior art systems which rely on an RFID tag carrying a unique product identification alone, the tag can be tracked by provision of a suitable central tracking system, and suitable data retrieval and communication means. However, fundamentally, this merely constitutes a tracking of the tag. If the tag is associated with a container, the container can then be tracked. However, the RFID tag alone provides no way of determining whether the contents of the container remain as expected, and remain uncompromised etc.

A conventional radiation detector alone allows the detection of radiation, for example if radiation leaks from a container, or if a container is opened to verify its contents, or if a source is not contained, but does not generally allow dynamic tracking of sealed containers where the very purpose of the container is to enclose a source and shield the radiation in the enclosed volume from the external environment, and where the enclosure is inherently compromised by or in any situation which might allow external detection of radiation.

However, by virtue of a combination in accordance with the invention, a unique product identification code fundamentally associated with the radioactive material source, and preferably with a contained source in a container, in the form of an identification module associated with the source and for example attached to or integral with the container, can be combined with a dynamic monitoring of the activity within the enclosed and shielded environment inside the container attributable to the stored radioisotope source. By provision of a suitable database, and suitable data capture means to allow data to be transmitted to a suitable central tracking system carrying that database, it is possible to combine in real time an ability to track containers and an ability to verify their contents, in particular without needing to interfere with those contents or open the container directly, and without fundamentally departing from the general principles employed for systems with a tracking capability.

The radiation detector is adapted to be placed within a container for radioactive material, which for example defines a shielded volume in use comprising a high-radiation environment, to detect radiation activity within the container. Conveniently, other components, for example comprising some or all of the elements constituting the radio frequency identification module, and at least comprising the antenna, are adapted to be placed in mechanical association with a container but outside a contained, radiation shielded and enclosed volume, in use comprising a low-radiation environment.

This deals in admirable manner with the very particular problems posed by the transport of enclosed radioactive sources, for example in a medical facility such as a hospital which are not encountered where conventional RFID tracking is employed for contained materials, as for example with large scale shipping containers.

Unlike the case with shipping containers that might carry radioactive material as a contaminant or contraband, the purpose of the enclosure is to carry a small source of radioactive material purposefully in an enclosed volume in an enclosed and radiation shielded manner such that it does not allow any radioactivity to escape from the enclosed volume. It follows that the enclosure will likely constitute a Faraday cage and that any RFID device that might be used will need to communicate from the outside of the enclosed volume. However, it also follows that the provision of a radiation detector outside the enclosed volume, such as might be considered for example to detect the unauthorised transfer of radiation in unsuitable containers, is inapplicable as in normal use there should be no radiation leak outside the enclosed volume.

These apparently contradictory requirements are met by the present invention, wherein the detector is placed in use inside the enclosed and shielded volume also containing the source in use, but the RFID module, or at least its antenna, is outside, and wherein a data connection is provided therebetween to pass data between the detector and the RFID module to allow information to be passed from inside the enclosed volume to the antenna outside the enclosed volume.

The data may concern whether the isotope is inside the container or not and/or whether it is the correct isotope. This raises specific problems not associated with solutions where an external detector or fully external tag are used, as might be known for example in larger scale tracking of larger scale shipping containers and in the detection of contraband radiation. For example, the particular adaptations of the invention will require control electronics inside and outside the enclosure, raising issues as to how each of these circuits will be powered. Also of significance is the fact that any electronics within the enclosure will either have to be radiation hardened or shielded from the radiation. Electrical and communications contact through the wall of the enclosure must not compromise its radiation seal, and will for example at least require a non-linear path. These are very specific requirements for this particular application and are not a problem related to the tracking or detection of contraband radiation in shipping containers.

Conveniently at least the data register, processor and antenna are compactly associated together in a single radio frequency identification unit. For example, some or all of such components may comprise a single integrated solid state electronics unit. Preferably, the radio frequency identification unit comprises a housing defining attachment means for releasable or permanent attachment of the unit to a radiation shielded container externally of the radiation shielded volume as a radio frequency identification tag. Alternatively, the unit or component parts thereof may be integrally formed as part of such a container.

For many practical applications the tracking device will preferably further comprise or be adapted for use with a power source to power one or more of the identification unit, the processor, the antenna, and the detector. Preferably the power source is portable so that the device can operate without the need for connection to a mains power supply. The device preferably comprises or is adapted for use with a portable power supply, for example comprising a battery or a hydrogen fuel cell. A single power supply may power all those elements of the remote device requiring separate power. For example, the radio frequency identification module components may comprise an active or semi-active device. The power source may additionally power the detector. The detector may have its own power supply.

In a more complete aspect of the invention, a trackable container for storage and transit of radioactive material comprises:
an enclosure of radioactive shielding material defining a shielded enclosed volume in which a radioactive material may be contained, and
a tracking device as above described mechanically associated with the container in such manner that at least the detector is within the shielded enclosed volume, and in such manner that the remainder of the device is in direct mechanical association with the container and that at least the antenna is outside the shielded enclosed volume.

The container comprises a suitable enclosure or capsule for safe handling of a radioactive source, for example in a medical facility such as a hospital. The container comprises a radiation shielded enclosure suitable for containing such a radioactive material in an enclosed and radiation shielded manner. The enclosure is configured such that it does not allow any radioactivity to escape. For example the enclosure is made from, or at least lined with, a dense metallic material such as lead.

At least the antenna is associated with the container outside the radiation shielded volume. In a preferred embodiment, at least the data register, processor and antenna are associated with the container outside the contained and radiation shielded volume, and consequently outside the environment subject to high radiation intensity from the contained source in use. For example, at least these components may be mounted on a surface of the container or incorporated into the structure of the container to be disposed outside the radiation shielded volume. At least these components may compactly associated together in a single radio frequency identification unit, optionally comprising a housing defining attachment means by which the unit is attached to the container as a radio frequency identification tag.

This arrangement is particularly preferred because the two active components of the combined device work best in different environments. The radio frequency identification transponder and processor module works best outside a high radiation environment. Most particularly, the antenna only works effectively outside the enclosed volume because the enclosure is a radiation shield and is therefore usually made from, or at least lined with, a dense metallic material that will constitute a Faraday cage. Therefore, at least the antenna, and in the preferred case the entire radio frequency identification transponder and processor module, is outside the shielded high radiation environment defined by the enclosed volume of the container.

By contrast, the detector is not intended to detect radiation activity outside the shielded environment to give an indication of failure of isolation, but is instead intended to detect routine radiation at all times from within the shielded environment, to provide a means of identifying the contained material without requiring access to the shielded enclosed volume, and is required to be inside the high radiation environment specifically to detect the radiation attributable to a contained source. The invention is not directed to detecting unintended radiation externally as a mere safety measure, but to detecting and characterising intended radiation internally for specific verification of contents. The detector must therefore be inside the shielded high radiation environment in the enclosed volume, alongside the source in use.

The data link allows activity data to be streamed to a processor and antenna outside the shielded environment from a detector inside the shielded environment as required, and hence allows a verification signal to be addressed from outside the shielded high radiation environment which is in part based on a real time verification of the contents inside the shielded high radiation environment (from the radiation signature detected therein) without compromising the radiation shield of the enclosure.

In a further more complete aspect of the invention, a system for tracking at least one radioactive material source comprises:
at least one tracking device as above described associated with such a radioactive material source and/or at least one radiation-shielded container as above described suitable for containing such a radioactive material in an enclosed and radiation-shielded manner;
a radioactive material management system which includes at least one database, the at least one database having a set of electronic data records stored therein providing an associative reference between a unique identification code and an expected radioactive activity behaviour for at least one, and preferably each, radioactive material source;
data capture means for capturing a data item including the unique product identification code and processed activity data from a tracking device from time to time, and for passing the data to the management system;
wherein the management system is adapted to make use of the unique product identification code thereby received to identify the first set of electronic data records stored in the dataset by association with that code, to make a comparison of the received activity data associated with that unique product identification code and predicted activity data from the database, and to output a result of that comparison as a verification of the radioactive material.

In a typical system there is provided a large plurality of tracking devices as above described each associated with a radioactive material source and/or with a container as above described suitable for containing such a radioactive material source, each of the data registers of the radio frequency identification modules of each such said device being provided with a unique product identification code. The at least one database will preferably then comprise a set of stored electronic data records providing an associative reference between each unique identification code and an expected radioactive activity behaviour for each associated source.

Thus, the central tracking system can track the location of each source/container and compare activity date with forecast activity level determined from knowledge of the supposed source/container contents, and in particular from elapsed time, half life etc. If the actual activity level does not correspond with the activity level forecast from the half life data then the source material can be assumed to be compromised, for example missing from the container, or being the incorrect radioisotope. The central tracking system, having identified such a verification failure, knows the location of container and can initiate an appropriate action to investigate the discrepancy.

If the measured activity level does correspond with the forecast activity level then the central tracking system can confirm that the correct radioisotope is in the correct container and position.

In a possible system, a plurality of automated and/or user-operated data capture units may be provided for capturing data from tracking devices at a plurality of remote distributed locations, some or all of the data capture units being remote from the management system, and in remote data communication therewith. Thus, a plurality of sources may be tracked at or via a plurality of remote locations.

In a possible system, the foregoing may be incorporated into an area access control such as a building access control, for example in that data capture units may be provided for capturing data from tracking devices at locations of controlled access to area/building and thereby to identify when a radioactive source material passes into or out of the area/building.

With appropriate control protocols it is then possible for example to:

permit entry only into those areas authorised to handle the radioisotope and only with personnel trained in the handling of the radioisotope;
prohibit radioisotope from entering unauthorised areas or entry with unauthorised personnel; or
prohibit a person and/or an isotope from leaving an area.

Conveniently, the radioactive material management system is adapted to output a verification data result in the form of a two state or pass/fail result indicating whether the contents of the container associated with the unique product identification code received correspond to the expected activity stored in the database, for example within predetermined tolerance limits.

When contents of a radioisotope container are verified by detector count rate to determine activity within the container the measured activity data can be recorded by the radioactive material management system to update half life activity calculations.

Communication between tracking device and radioactive material management system and where applicable between remote data capture units and tracking devices and radioactive material management system is preferably wireless with communication being performed by known wireless communication means. Alternatively, for example especially in the case of communication between management system and data capture units, communication may be wired.

The detector may be adapted to work in continuous mode, to detect at fixed time intervals, or to detect when the identification unit is interrogated by a remote data capture unit.

In order to preserve power for the detector to increase life of the portable power supply, a count rate to determine activity is preferably only taken when a container is closed and sealed.

The detector preferably comprises a detector element fabricated from a semiconductor material or materials selected to exhibit inherently as a direct material property a direct variable electrical and for example photoelectric response to source radiation. For example the semiconductor material is a wide direct bandgap semiconductor.

In a preferred case, the semiconductor material making up the detector element preferably comprises material having a high absorption for gamma rays so that a detector of relatively small size, for example smaller than 5 cm³ and preferably smaller than 1 cm³, can still give a good activity count rate. This allows the detector to be kept small. This means, particularly in the case of the preferred embodiment where components of the radio frequency identification module are compactly associated together in a single compact unit that the tracking device of the invention need take up relatively little space. It is generally undesirable, when the tracking device is used with a container, and in particular when at least the detector is within the container, for the tracking device/detector to be too large. A container defines a shielded volume in which a radioisotope source material can be placed, which is typically made of dense and/or expensive material. Anything which increases the container size is undesirable. A compact tracking device in accordance with the present invention, with a compact detector fabricated from a dense material, reduces this problem.

The detector element preferably comprises a semiconductor material or materials formed as a bulk crystal, and for example as a bulk single crystal (where bulk crystal in this context indicates a thickness of at least 500 μm, and preferably of at least 1 mm).

The materials making up the semiconductor detector element are preferably selected from cadmium telluride, cadmium zinc telluride (CZT), cadmium manganese telluride (CMT), germanium, lanthanum bromide, thorium bromide. Group II-VI semiconductors, and especially those listed, are particularly preferred in this regard.

The materials making up the semiconductor detector element are preferably selected from cadmium telluride, cadmium zinc telluride (CZT), cadmium manganese telluride (CMT) and alloys thereof, and for example comprise crystalline Cd_{1-(a+b)}MnₐZn_{b}Te where a+b<1 and a and/or b may be zero.

A detector in accordance with the invention may comprise a single detector element or a plurality of discrete detector elements making up a multi-element system. A detector may have no spatial resolution, which counts radiological activity only, or a detector may be capable of resolving incident radiation spatially.

A system in accordance with the invention comprises various data processing and data storage modules performing various data processing and data storage functions. It will be understood generally that a data processing module of the invention can comprise and data storage function invention can be implemented by a suitable set of machine readable instructions or code. These machine readable instructions may be loaded onto a general purpose computer, special purpose computer, or other programmable data processing apparatus. For example the radioactive material management system and/ or the at least one database thereof may be provided by such machine readable instructions loaded onto a suitable programmable data processing apparatus.

These machine readable instructions may also be stored in a computer readable medium that can direct a computer or other programmable data processing apparatus to function in a particular manner, such that the instructions stored in a computer readable medium produce an article of manufacture including instruction means to comprise some or all of the elements of the tracking system of the invention, and in particular of the radioactive material management system. Computer program instructions may also be loaded onto a computer or other programmable apparatus to produce a machine capable of implementing a computer executed process such that the instructions are executed on the computer or other programmable apparatus providing some or all of the elements of the tracking system of the invention, and in particular of the radioactive material management system of the invention. It will be understood that a tracking system may comprise any suitable combinations of special purpose hardware and/ or computer program instructions on a programmable data processing apparatus.

In a further aspect of the invention, there is provided a method of tracking and verification of a radioactive material source, and more preferably of a plurality of such sources, over time, the method comprising:
associating a radiation detector with a radioactive material, by placing a radiation detector within a container a radiation shielded enclosed volume in which is contained radioactive material;
associating a radio frequency identification module with a radioactive material in data communication with the radiation detector, which module comprises at least a data register to store a unique product identification code, a processor to receive and process a data stream of activity data from the detector and associate this with the unique product identification code, and an antenna, such that at least the antenna is placed in mechanical association with a container but outside the radiation shielded enclosed volume;
operating the processor to produce a data item comprising both the unique product identification code and processed activity data;
retrieving the data item via a remote data capture means;
passing the data item to a radioactive source material management system which includes at least a database having a set of electronic data records stored therein providing an associative reference between a unique identification code and an expected radioactive activity behaviour for each radioactive material source;
for each data item so transmitted, using the unique product identifications code received by the management system to identify the first set of electronic data records stored in a data set by association with that code;
comparing predicted activity data from the database with received activity data, for example within predetermined tolerance limits;
outputting the result of that comparison as a verification of the radioactive material source.

In a preferred embodiment, a plurality of tracking devices are provided, each associated with an individual radioactive material source by being placed in mechanical association with and for example on a container enclosing such an individual source in a radiation-shielded manner.

A processor of an identification module may operate to process activity and identification data as above described on a continuous basis, on a periodic basis during a set time interval, or when interrogated by a remote data capture means as part of the data capture step. Where a system comprises multiple tracking devices and/or multiple data capture means the method may be performed periodically or continuously, by an automated process under user control, based on the proximity of a detector to a data capture means, or otherwise as required.

The method is in particular therefore a method of use of a tracking device and system as here and before described, and other preferred features of the method will be understood by analogy.

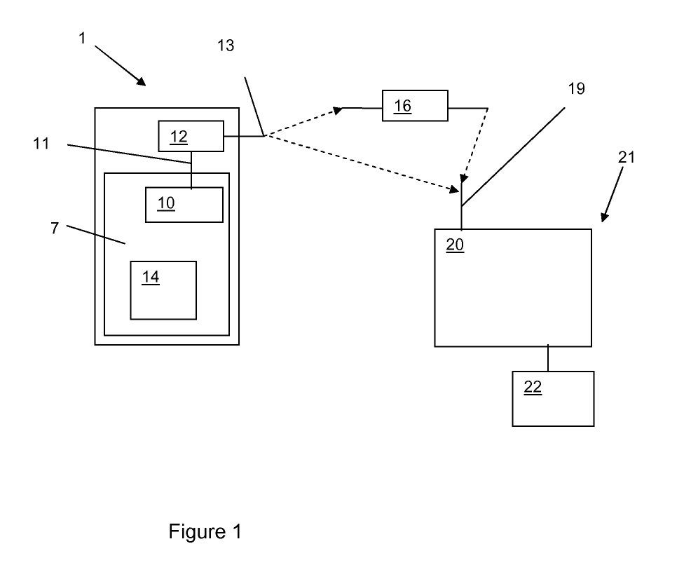

The invention will now be described by way of example only with reference to the accompanying FIG. 1, which is a general schematic of a possible tracking system operating in accordance with an embodiment of the invention, and making use of a tracking device in accordance with an embodiment of the invention.

FIG. 1 illustrates a simple schematic of a tracking system in accordance with the invention in which is illustrated a single container 1 for a radioisotope source in communication with a central tracking management system 21. Of course, it will be understood that in practice a large plurality of such containers will typically be provided, tracked for instance from one or a small number of central tracking locations.

A container 1 defines a shielded volume 7, for instance shielded by a suitable radiation shielding wall material, in which a radioisotope source 14 that it is desirable to track is contained. Also within the volume 7, a detector 10 is provided comprising a detector element of suitable semiconductor material, in the embodiment comprising cadmium telluride, cadmium zinc telluride, cadmium magnesium telluride or some suitable alloy combination thereof, together with a suitable control electronics to receive and process the response of the semiconductor to radiation activity within the container and to pass the same via the data link 11.

The precise structure of control electronics is not particularly pertinent to the invention. The selection of materials is significant, since it is desirable that the detector element is relatively small and dense. Conventional large detector elements are impractical in this application, since a large detector element, which necessarily then takes up a large space in the volume 7, requires the overall container 1 to be larger. This makes it heavier and more expensive, particularly given the significant material requirements imposed by the need for radiation shielding. A compact detector element, such as is offered by cadmium telluride, significantly reduces the size of the overall detector apparatus, and makes a detector within the contained volume practical.

Radiation activity data collected by the inherent response of the detector element is passed via the data link 11 to a radio frequency identification device (RFID) 12 which includes a unique code identifying the particular container 1. The RFID device 12 is additionally modified to include a processing means which enables it to cope with a live data stream via the data link 11 from the detector 10. This is processed in such a manner that the unique product identification data is associated with the data stream of activity data in a single transmittable data packet which may then be passed via the antenna 13 to a receiver remotely stationed from the container 1 for example by active transmission or on interrogation by the receiving station.

A power source, preferably comprising a portable power source such as a battery or hydrogen fuel cell, may be provided (not shown) in or in association with the container to power the detector 10. Preferably, the detector is activated only when the container is filled and sealed. This or a further source may additionally power the RFID device 12 or components thereof such as the processor and/or antenna. Thus, preferably, the RFID device 12 may be an active or semi-active RFID device.

Of necessity, the detector, or at least the detector element, must be within the shielded volume 7 in order to detect radiation activity therein with a radioisotope source 14 contained in the shielded volume 7. However, this provides a generally harsh environment electronically, and accordingly it is preferable, as in the illustrated embodiment, that the RFID device 12 and as much as possible of the associated control electronics and system is located outside the shielded volume, for example in a separate compartment of the container or on a surface thereof.

Data from the RFID device 12 including both unique container identification data and real time streamed radiation activity data from the shielded volume may be passed via the antenna 13 to a central management system 21. Two possible transmission paths are illustrated. In a simple embodiment, a receiving antenna 19 captures information directly to a central processor 20 of the central tracking system 21. In a more practical expanded system, multiple data capture means 16 are provided, which will typically be remotely distributed from the central management system 21, for example at a plurality of remote monitoring locations, to capture data from a plurality of RFID devices 12, and to transmit the same onward to a central management system. Such a general arrangement of tagged containers, remote data capture units, and central processing system will be familiar from general identification and tracking systems.

However, where the system in accordance with the invention differs notably is in that a data packet transmitted by the RFID device and ultimately retrieved and processed by the central processor 20 of the central tracking system includes not only mere identification data but also streamed data regarding activity within the contained volume associated with the container carrying that unique identification. The central processor unit 20 includes a data store which stores predicted activity data in an association library accessible with reference to a unique product identification code for each of the containers within the system and for each of their respective contents. The central processor includes a comparison module to compare received live streamed activity data from within a container with the predicted data calculated from the stored information, and uses this to verify the contents. Monitoring and tracking of the contents of a container, and thus in a more direct sense of the radioactive source as such is possibly in a dynamic, real time manner without accessing or otherwise requiring examination of the containers themselves, via a data transfer process which is no more complex in organisation than that of a conventional system which provides for mere container identification and tracking alone.

1. A tracking device for use with a radioactive material comprising: a radiation detector associatable with a radioactive material in that it is adapted to be placed within a container for containing a radioactive material in a radiation shielded enclosed volume, to detect radiation activity from the material in the enclosed volume; a radio frequency identification module associatable with a container for containing a radioactive material in a radiation shielded enclosed volume, which comprises at least: a data register to store a unique product identification code, a processor with a data transfer link to each of the radiation detector and data register to receive and process a live data stream of activity data from the detector and associate this with the unique product identification code in a processed data packet, an antenna to enable transmission of a data item comprising both the unique product identification code and processed activity data to a remote data capture means; wherein at least the antenna is adapted to be placed in mechanical association with a container but outside the radiation-shielded enclosed volume.

2. A tracking device in accordance with claim 1 wherein some or all of the elements other than the antenna constituting the radio frequency identification module are adapted to be placed in mechanical association with a container but outside the radiation-shielded enclosed volume, in use comprising a low-radiation environment.

3. A tracking device in accordance with claim 1 wherein at least the data register, processor and antenna are compactly associated together in a single radio frequency identification unit.

4. A tracking device in accordance with claim 3 wherein the radio frequency identification unit comprises a single integrated solid state electronics unit.

5. A tracking device in accordance with claim 3 wherein the radio frequency identification unit comprises a housing defining attachment means for releasable or permanent attachment of the unit to a container as a radio frequency identification tag.

6. A tracking device in accordance with claim 1 further comprising a power source to power one or more of the identification unit, the processor, the antenna, and the detector.

7. A tracking device in accordance with claim 6 wherein the power source is portable, comprising a battery or a hydrogen fuel cell.

8. A tracking device in accordance with claim 1 wherein the detector comprises a detector element fabricated from a semiconductor material or materials selected to exhibit inherently as a direct material property a direct variable photoelectric response to source radiation.

9. A tracking device in accordance with claim 8 wherein the semiconductor material is a wide direct bandgap semiconductor.

10. A tracking device in accordance with claim 8 wherein the semiconductor material is formed as a bulk single crystal.

11. A tracking device in accordance with claim 8 wherein the materials making up the semiconductor detector element are selected from cadmium telluride, cadmium zinc telluride (CZT), cadmium manganese telluride (CMT), germanium, lanthanum bromide, thorium bromide.

12. A tracking device in accordance with claim 11 wherein the materials making up the semiconductor detector element are selected from cadmium telluride, cadmium zinc telluride (CZT), cadmium manganese telluride (CMT) and alloys thereof.

13. A trackable container for storage and transit of radioactive material comprises:
an enclosure of radioactive shielding material defining a shielded enclosed volume in which a radioactive material may be contained, and
a tracking device in accordance with claim 1 mechanically associated with the container in such mariner that at least the detector is within the shielded enclosed volume, and in such manner that the remainder of the device is in direct mechanical association with the container and that at least the antenna is outside the shielded enclosed volume.

14. A trackable container in accordance with claim 13 wherein at least the data register, processor and antenna are associated with the container outside the contained and shielded volume.

15. A trackable container in accordance with claim 14 wherein the data register, processor and/antenna are mounted on a surface of the container or incorporated into the structure thereof.

16. A system for tracking at least one radioactive material source comprising:
at least one radiation-shielded container and tracking device in accordance with claim 13 associated with such a radioactive material source, the container suitable for containing such a radioactive material in an enclosed and radiation-shielded manner;
a radioactive material management system which includes at least one database, the at least one database having a set of electronic data records stored therein providing an associative reference between a unique identification code and an expected radioactive activity behaviour for at least one radioactive material source; data capture means for capturing a data item including the unique product identification code and processed activity data from a tracking device from time to time, and for passing the data to the management system;
wherein the management system is adapted to make use of the unique product identification code thereby received to identify the first set of electronic data records stored in the dataset by association with that code, to make a comparison of the received activity data associated with that unique product identification code and predicted activity data from the database, and to output a result of that comparison as a verification of the radioactive material.

17. A system in accordance with claim 16 comprising a large plurality of tracking devices each associated with a radioactive material source and/or with a container suitable for containing such a radioactive material source, each of the data registers of the radio frequency identification modules of each such said device being provided with a unique product identification code.

18. A system in accordance with claim 16 further comprising a plurality of automated and/ or user-operated data capture units for capturing data from tracking devices at a plurality of remote distributed locations, some or all of the data capture units being remote from the management system, and in remote data communication therewith.

19. A system in accordance with claim 16 wherein the radioactive material management system is adapted to output a verification data result in the form of a two state or pass/fail result indicating whether the contents of the container associated with the unique product identification code received correspond to the expected activity stored in the database within predetermined tolerance limits.

20. A method of tracking and verification of a plurality of radioactive material sources, over time, the method comprising:
associating a radiation detector with a radioactive material by placing a radiation detector within a container defining a radiation-shielded enclosed volume in which is contained radioactive material;
associating a radio frequency identification module with a radioactive material in data communication with the radiation detector, which module comprises at least a data register to store a unique product identification code, a processor to receive and process a data stream of activity data from the detector and associate this with the unique product identification code, and an antenna, such that at least the antenna is placed in mechanical association with a container but outside the radiation-shielded enclosed volume;
operating the processor to produce a data item comprising both the unique product identification code and processed activity data;
retrieving the data item via a remote data capture means;
passing the data item to a radioactive source management system which includes at least a database having a set of electronic data records stored therein providing an associative reference between a unique identification code and an expected radioactive activity behaviour for each radioisotope source;
for each data item so transmitted, using the unique product identifications code received by the management system to identify the first set of electronic data records stored in a data set by association with that code;
comparing predicted activity data from the database with received activity data within predetermined tolerance limits; and
outputting the result of that comparison as a verification of the radioactive material source.

21. A method in accordance with claim 20 wherein a plurality of tracking devices are provided, each associated with an individual radioactive material source.

22. A method in accordance with claim 20 wherein a plurality of remote data capture means are provided, and data is collected at a plurality of locations.
